(19) United States
(12) Patent Application Publication
(10) Pub. No.: US 2017/0287038 A1
(43) Pub. Date: Oct. 5, 2017

(54) ARTIFICIAL INTELLIGENCE NEGOTIATION AGENT

(71) Applicant: Microsoft Technology Licensing, LLC, Redmond, WA (US)

(72) Inventor: Georgios Krasadakis, Dublin (IE)

(21) Appl. No.: 15/087,870

(22) Filed: Mar. 31, 2016

(51) Int. Cl. G06Q 30/06; G06Q 30/02

(52) U.S. Cl. CPC G06Q 30/0613; G06Q 30/0201

(57) ABSTRACT

Discussed herein is a server-implemented framework that automates the discovery and negotiation of product sales online based on buyer- and seller-defined parameters and elasticity thresholds. Artificial intelligence (AI) negotiation agents operate on behalf of the buyers and sellers to locate potential deals, automatically and anonymously negotiate towards the best terms for their respective users based on the parameters set by the users to be important and also based on market conditions. The AI negotiation agents join a multi-stage negotiation session until sufficiently improved offers are obtained for particular products and services. These negotiated, improved, offers are then transmitted to the buyers and sellers for acceptance. The AI agent for Sellers optimizes sales strategy and effectiveness while the AI agent for Buyers improves purchasing decision-making and empowers better deals with less effort.

### BACKGROUND

There are numerous outlets for purchasing products and services today. Information about products and services has virtually exploded in the Information Age. Between online product reviews, social media posts, product trends, user suggestions, blogs, frequently changing prices, loosely defined offers, and unreliable product/service providers, consumers today must sift through various online and brick-and-mortar retailers to find the best deals on the things they want to purchase. So consumers making purchasing product decisions often deal with information overload, market noise, pricing gaps, and conflicting product-review signals.

At the same time, retailers have to manage product and service advertisement across different advertisement channels (e.g., print, radio, television, online) that each require different marketing techniques, and often complex campaign-management solutions. In the end, regardless of the medium, retailers must effectively predict what consumers want in order to better target and promote their offerings.

### SUMMARY

The disclosed examples are described in detail below with reference to the accompanying drawing figures listed below. The following summary is provided to illustrate some examples disclosed herein, and is not meant to necessarily limit all examples to any particular configuration or sequence of operations.

Some examples are directed to a framework in which artificial intelligence (AI) negotiation agents (otherwise known as robots or “bots”) are used to identify products or services and negotiate offer terms for buyers and sellers. A buyer may specify particular buying parameters and corresponding buying-parameter elasticity that are used to create and manage a buyer AI negotiation agent on a server. The buyer AI negotiation agent is aware of the buyer's overall budget, needs, preferences and buying patterns etc. which can utilize to achieve better deals for the buyer. Similarly, product sellers may create seller AI negotiation agents that manage selling campaigns in a manner that is bound by selling parameters and associated seller elasticity thresholds. The seller AI negotiation agent is aware of and using the overall goals and objectives set by the seller, product catalogue and stock information, pricing elasticity and priorities, as set by the seller. The buyer AI negotiators locate seller AI negotiators, and vice versa and may join a multi-stage negotiation process possibly leading to a pre-agreement to be reviewed by the buyer or a final agreement leading to a commercial transaction. The multi-stage negotiation process involves autonomous communication, back and forth between the Seller AI Agent and the Buyer AI agent aiming in an improved deal—the negotiated offer terms—that may be presented to the respective buyers and sellers for acceptance.

### BRIEF DESCRIPTION OF THE DRAWINGS

The disclosed examples are described in detail below with reference to the accompanying drawing figures listed below:

FIGS. 1A-1B are exemplary block diagrams illustrating computing devices for implementing AI negotiation agents.

FIG. 2 is an exemplary block diagram illustrating a networking environment for providing AI negotiation agents to execute negotiation campaigns.

FIG. 3 is a flow chart diagram that illustrates a work flow for creating and operating a buyer AI negotiator.

FIG. 4 is a flow chart diagram that illustrates a work flow for creating and operating a seller AI negotiator.

FIG. 5 is a flow chart diagram that illustrates a work flow for a buyer AI negotiator to locate and process negotiation offers from seller AI negotiators.

FIG. 6 is a flow chart diagram that illustrates a work flow for a seller AI negotiator to generate and negotiate product offers.

FIG. 7 is a flow chart diagram that illustrates a work flow for assessing a product offer.

Corresponding reference characters indicate corresponding parts throughout the drawings.

### DETAILED DESCRIPTION

The examples disclosed herein generally relate to an AI-powered framework whereby autonomous AI agents negotiate deals on behalf of buyers and sellers. The buyers and sellers may communicate using the disclosed framework in an optimized way that allows various aspects of purchasing deals to be negotiated and adjusted nearly instantly. In some examples, the consumers use their client devices (e.g., laptop, smart phone, tablet, etc.) to anonymously organize and set up automated, on-going buying plans executed by multi-criteria decision-making negotiation agents on a server, referred to herein as “buyer AI negotiators” (“AI buyers,” “AI buyer agent,” “consumer bot,” or “purchasing bot” for short), for purchasing particular products (e.g., 2016 Tesla model S) or types of products (e.g., compact sedan automobile). At the same time, some examples allow retailers to set up automated, on-going selling plans or selling campaigns executed by multi-criteria decision-making negotiation agents on a server, referred to herein as “seller AI negotiators” (or “AI sellers” “AI seller agent” for short), that offer the seller's products or services and automatically negotiate purchasing deals with the buyer AI negotiators.

As a general introduction, the AI negotiators broadcast what the buyers and sellers are looking to purchase and sell, respectively, and in some examples, this is how initial matches between the buyer and seller AI negotiator bots are made. Along these lines, a pairwise communication begins negotiations based on the parameters and the strategy setup for each agent. In some examples, the buyer AI negotiators monitor the offers from the seller AI negotiators and negotiate the best deals possible based on pre-defined buying parameters and buyer elasticity set by the buyer. Similarly, the seller AI negotiators negotiate the best deals possible for the sellers based on pre-defined buying parameters and seller elasticity set by the seller. The disclosed examples allow a buyer to create a buyer AI negotiator for a product or service that interacts with the various seller AI negotiators of the retailers and identifies where to purchase the requested product or service based on buying parameters and elasticity of the consumer.

To create the buying and selling plans that are autonomously negotiated by the AI negotiators disclosed herein, some examples provide a negotiation application as part of the operating system (OS) of a client device (e.g., laptop, smart phone, tablet, etc.) or as downloadable application that may be installed on the client device. The pre-installed or downloadable application enables consumers and retailers to create the buyer and seller AI negotiators to intelligently find, offer, and negotiate products and services. Users are anonymously represented online by their respective AI (buyer or seller) negotiator, which is able to understand what the user wants (through the pre-defined buying and selling parameters) and what sort of negotiation elasticity either side will accept.

The buying and selling plans respectively include buyer and seller parameters, goals, and objectives that may take into account a whole host of product, market, and social information, allowing these agents to consider purchasing deals from the various angles that humans consider. These buyer and seller parameters may be set or focused on product information, product specifications, pricing, pricing dynamics, pricing predictions, inventory (e.g., how many units are currently or will prospectively be in stock, inventory predictions based on trends, competition, buyer movement, etc.), shipping information (e.g., when products may be delivered), seasonality (e.g., when products are considered “in season” or “out of season”), trends (e.g., the amount or proportion of product sales at any given time), social media (e.g., discussion of particular products through various social media outlets), supply and demand (e.g., across multiple retailers), industry news, and the like.

More specifically, the product information comprises product instances, product specifications, or other product descriptions for a given product, e.g., a particular model of automobile, particular amount of horsepower, a particular capacity to carry certain numbers of passengers, etc. Product pricing may include actual prices, discounted prices (e.g., 5% off), relative pricing (e.g., 3% less than another seller), conditional pricing (e.g., if inventory levels exceed a particular threshold, then discount price by a certain amount), pricing increases based on detected need (e.g., large demand for product, seller needs product within an expedited timeframe, etc.), a combination thereof, or the like. Market or product trends may take into account seasonality of products, influx of product sales, product advertisements or media presentations (e.g., if the product is mentioned on a popular television or radio program), or the like. Social media messages, images, video, audio, user friend connections, public comments, direct messages, brand suggestions, preferences, and other posts may also be monitored and used to influence product AI negotiation decisions. Supply and demand figures, either from a market perspective (e.g., a collection of retailers are out of a product) or from the individual retailer perspective may also be used to vary negotiations between the AI buyer and seller agents. Additional and alternative buyer and seller parameters may also be used, as this list is not meant to be exhaustive.

In some examples, buying and selling parameters provided by the buyers and sellers, respectively, are combined with buying and selling goals and objectives define the strategies the AI negotiators follow. From the seller perspective, seller overall campaign goals may be implemented across multiple seller AI negotiators. For example, a strategy may be something like: sell at least x volume of product A, with an average/min profit margin. In a more complex scenario, the seller may setup multiple seller AI negotiators that all work together to achieve a shared goal in terms of product volume sold, cumulative revenue, cumulative profit, and/or stock re-circulation, all against a predefined time window. Each seller AI negotiator seller may take into consideration the seller's described parameters and also the state and rate of completeness of the shared goal, as determined cumulatively across all the seller AI negotiators. For instance, if at the start of the time window, a few seller AI negotiators achieve unexpectedly high profit margins for product A, then other AI negotiators for the same or other products, may increase the elasticity regarding profit margins because the shared goal is most likely going to be met. In this manner, multiple seller AI negotiators may work together on shared goals of the seller.

Along these same lines, from a buyer's perspective, a buyer may set buying plans that include a certain budget (e.g., monthly budget, annual budget, etc.). The budget may be considered to have an upper limit set by the user, but the corresponding agents may collectively work to minimize or optimize the total amount spent. This optimization may allow a buyer AI negotiator to increase its own budget by the amount saved by another buyer AI negotiator of the buyer. For example, if the buyer set the total spend to be $12,000 over the year for a product with twelve buyer AI negotiators being allotted $1,000 budgets each, the budgets of those agents may be increased (proportionally or not) if one of the buyer AI negotiators was able to purchase the product at a particular discount. In this manner, the buyer AI negotiators may not only work together to achieve the goals of the buyer, but may also discount each other based the success or failure of negotiations in the market place.

For purposes of this disclosure, “elasticity” refers to a difference in at least one of the buying or selling parameters, and an “elasticity threshold” refers to an upper or lower limit for a buying parameter. For example, a buyer may be willing to pay a price for a product that ranges ten percent (e.g., $100-$110). Or a seller may be willing to match whatever the lowest price (or a certain percentage, such as 5%, above the lowest price) of the going price for a particular product in the marketplace. Price is not the only parameter that may be elastic. Any of the disclosed buying and selling parameters may be elastic to some extent. Elasticity may be set by the buyer and seller themselves, by the current market conditions, by product availability, by the seasonality or trends of products, by social media or online commentary, by product reviews, or a combination thereof or by the overall performance and completion rate in reference to the strategic goals and objectives. For instance, buyers and sellers may specify particular elasticity ranges for their respective AI buyer and seller agents.

Moreover, elasticity may be modeled in various ways. For example, elasticity parameters may specify acceptable ranges, distances, or other deviations from a target value. In other examples, elasticity parameters may use weight factors to inform an AI negotiator how important the particular attribute/parameter is for a buyer or seller. Any combination of the buying, selling, and negotiation parameters disclosed herein may be combined and varied to create the elasticity parameters mentioned herein.

Additionally or alternatively, some parameters may be defined as “blockers,” meaning that, regardless of whether other parameters or elasticity thresholds are met, if a blocker parameter is detected, an offering from the seller AI negotiators are not to be considered. For example, if a user is looking for a particular vehicle that has certain specifications (e.g., horsepower) but only wants to purchase a new vehicle, all seller AI negotiators attempting to sell a used version of the vehicle will be excluded, regardless of whether the used vehicles contain the sought-after specification. In another example, if a buyer wishes to purchase a product by a particular deadline, all seller AI negotiators offering the product with delivery terms that do not meet the buyer's deadline will be blocked. In still another example, a seller may specify that buyers who are located in particular locations (e.g., states) may be excluded as purchasers due to the fact that the seller does not have the appropriate licensing to the sell the product or service in that area. Numerous other examples exist; however, they need not be exhaustively discussed to understand the fact that, as part of the buying and selling plans, the buyers and sellers may set certain blockers to preclude negotiations.

For the sake of clarity, many of the examples disclosed herein reference “products” to illustrate the various capabilities of the AI negotiation techniques and agents. These same AI negotiation techniques and agents may be used to negotiate services as well. For instance, the same AI buyer and seller agents may negotiate, telecommunication services, insurance contracts, educational programs, automobile repairs, doctor visits, and attorney representations in the same manner as negotiation actual products. For service in particular, the AI agents may additionally negotiate times for performance of the requested services, taking into account the buyer- and seller-specified timeframes for service requests and availability, respectively, with time elasticity built in (e.g., within a certain number of hours on a particular data).

Also, the buyer and seller AI negotiation agents are described herein as “negotiating” with each other, which perhaps personifies the agents to some extent. It should be noted, however, that in some examples the buyer and seller AI negotiation agents operate autonomously from their respective buyers and retailers in the negotiation of purchase deals for products. In some examples, AI agent negotiation is accomplished by the seller AI negotiation agents respectively taking the predefined buyer and seller parameters and elasticity and identifying buyer-retailer pairings that facilitate the best product transactions. For example, a multitude of seller AI negotiation agents offering the desired products being searched for by an AI negotiation agent within elasticity thresholds of the various of buyer parameters (e.g., within 10% of price, having 90% of the desired product specifications, with an availability within hours or a day of the buyer's request, being mentioned a certain number of times in social media, etc.) cause some of the disclosed examples to create a list of retailer product offerings to present to the buyer, or may automatically purchase the products from one of the sellers in view of the buyer's preset authorization.

Negotiation between the AI negotiation agents is carried out, in some examples, through a weighting of the various buyer and seller parameters and elasticity. The weights associated with the various buyer and seller parameters may be set by the buyers and retailers themselves. For example, a buyer may indicate that a particular price may not be exceeded, that delivery dates are flexible to a certain extent, but that the product must absolutely be purchased, thereby assigning a “high” ranking to obtaining the product, a “medium” weight factor to the price, and a “low” ranking to the delivery time/date. As such, the buyer-submitted elasticity (i.e., variance) of the delivery and price may be less important, meaning the AI buyer agent may concede to the such demands of AI seller agents, so long as the product is obtained. Similar weights may be assigned to the seller parameters and used in the negotiation of elastic terms by the retailer's AI seller agent.

In operation, some examples include executable instructions that cause the buyer AI negotiation agents to locate seller AI negotiation agents and identify a list of the most optimal potential product offerings and consumers searching for products based on analysis of the parameter rankings and elasticity. Again, in some examples, the rankings may indicate which parameters the buyer believes are more important (e.g., price, delivery, specifications, availability, etc.), and the negotiations between the buyer and seller AI negotiation agents may be conducted based on such weightings.

Once lists of seller AI negotiation agents are identified, in some examples, the buyer AI negotiation agent negotiates purchase details with the various seller AI negotiation agents to obtain the best deal for the buyer. Purchase details may vary by price, delivery time, product specification (e.g., 200 horsepower versus 250 horsepower model of automobile, 32 GB of RAM versus 64 GB, etc.), or any other buying or selling parameter mentioned herein—or a combination thereof. For example, the buyer AI negotiation agent may submit varying proposed purchase prices to the various seller AI negotiation agents, which in turn either indicate that the proposed prices are accepted or respond with proposed counter-offer prices that may be evaluated by the buyer AI negotiation agent. These back-and-forth negotiations enables the buyer and seller AI negotiation agents to quickly determine each other's allowable elasticity for the various buying and selling parameters, and such determinations may then be used by the buyer and seller AI negotiation agents to select optimal candidate (buyer and retailer) purchase a product or present to the buyers and sellers to purchase the product.

The disclosed examples provide a robust framework for enhancing user negotiating experiences and product identification. Users no longer need to constantly monitor various social and retail web sites or check products at local stores to find the deal that are best tailored for the users. Instead, using the examples disclosed herein, users anonymously communicate to the market their purchasing intentions, and thus products may be discovered quickly through access to various AI seller agents, and the best purchase parameters may be secured through automatic AI agents that search and negotiate on behalf of the buyers.

Similarly, sellers may set product selling campaigns that automatically locate, negotiate with, and secure potential product buyers, having explicitly stated their intention to buy what the sellers are trying to sell, without having to test standard predictive campaigns through conventional selling channels. This saves sellers considerable time and advertising resources from having to customize advertising campaigns that may or may not attract buyers. Such advertising campaigns are normally crafted using computers, and often require processor-intensive advertising software to create, edit, and publish selling campaigns. Such computer processing time and human effort on defining tailor-made and human-operated campaigns which are based on assumptions and predictions on what the consumer want, are no longer required with the described framework.

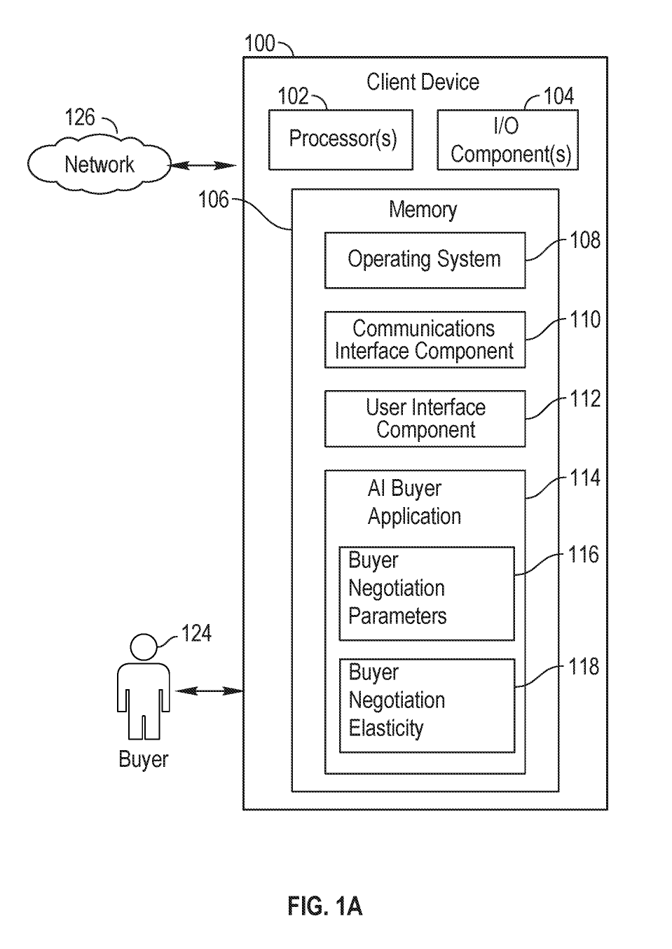

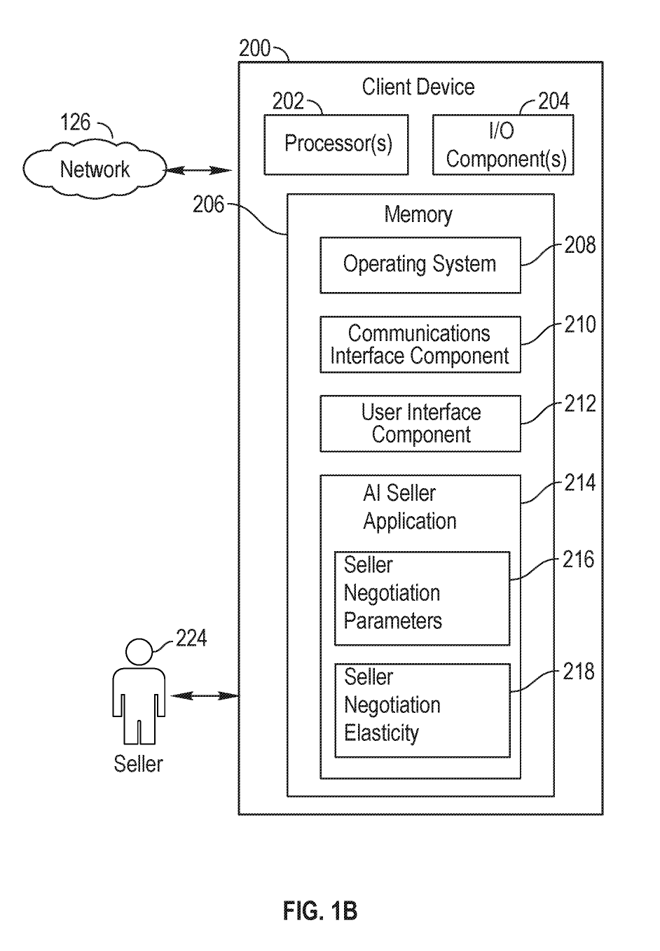

Having generally described at least some of the examples disclosed herein, attention is focused on the accompanying drawings for additional details. FIG. 1A is an exemplary block diagram illustrating a client computing device (“client device”) 100 for creating a buyer AI negotiation agent. The client device 100 represents any device executing instructions (e.g., as application programs, operating system functionality, or both) to implement the operations and functionality described herein associated with the client device 100.

The client device 100 may take the form of a mobile computing device or any other portable device, such as, for example but without limitation, a mobile phone (e.g., smart phone), a laptop, a tablet, a computing pad, a netbook, a gaming device, a virtual reality (VR) headset or device, a wearable device (e.g., smart glasses, fitness band, electronic watch, etc.), and/or a portable media player. The client device 100 may also include less portable devices such as desktop personal computers, kiosks, tabletop devices, electric automobile charging stations, electronic component of a vehicle (e.g., a vehicle computer equipped with cameras or other sensors disclosed herein), or the like. Other examples may incorporate the client device 100 as part of a multi-device system in which two separate physical devices share or otherwise provide access to the illustrated components of the client device 100.

In some examples, the client device 100 has at least one processor 102, one or more input/output (I/O) components 104, and computer-storage memory 106. More specifically, the computer-storage memory 106 is embodied with machine-executable instructions comprising an operating system 108, a communications interface component 110, a user interface component 112, and an AI buyer application 114. The AI buyer application 114 may be included as part of the operating system 108 or downloadable over the network 126.

The processor 102 may include any quantity of processing units, and is programmed to execute computer-executable instructions for implementing aspects of the disclosure. The instructions may be performed by the processor, by multiple processors within the computing device, or by a processor external to the client device 100. In some examples, the processor 102 is programmed to execute instructions such as those illustrated in the flowcharts discussed below and depicted in the accompanying drawings. Moreover, in some examples, the processor 102 represents an implementation of analog techniques to perform the operations described herein. For example, the operations may be performed by an analog client device 100 and/or a digital client device 100.

The I/O components 104 may include display, audio, haptic, and other presentation devices that visibly, audibly, or otherwise present information to the buyer 124. The I/O components 104 may include various presentation components and corresponding I/O ports and device drivers, including, for example but without limitation, display screens, monitors, touch screens, phone displays, tablet displays, wearable device screens, televisions, speakers, vibrating devices, tactile-morphing screens, headphones and headphone inputs, holographic displays, virtual reality displays, augmented reality displays, and any other devices configured to display, verbally communicate, or otherwise indicate output to a user. Additional presentation components readily apparent to one skilled in the art may also be included.

The computer-storage memory 106 includes any quantity of memory associated with or accessible by the client device 100. Memory 106 may be internal to the client device 100 (as shown in FIG. 1), external to the client device 100 (not shown), or both (not shown). Examples of memory 106 include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other form of device memory.

Memory 106 may also take the form of volatile and/or nonvolatile memory; may be removable, non-removable, or a combination thereof; and may include various hardware devices (e.g., solid-state memory, hard drives, optical-disc drives, etc.). Additionally or alternatively, memory 106 may be distributed across multiple client devices 100, e.g., in a virtualized environment in which instruction processing is carried out on multiple client devices 100. For the purposes of this disclosure, “computer-storage memory” and “memory” do not include carrier waves or propagating signaling.

As shown in the depicted example, memory 106 stores instructions for an operating system 108, a communications interface component 110, a user interface component 112, and an AI buyer application 114. Also, the AI buyer application 114 comprises buyer negotiation parameters 116 and buyer negotiation elasticity thresholds (“buyer negotiation elasticity”) 118 received from the buyer 124 or through negotiations with the AI seller agents, as discussed in more detail below. One skilled in the art will appreciate and understand that numerous other computer program modules may also be stored in memory 106.

In some examples, the communications interface component 110 includes a network interface card and/or a driver for operating the network interface card. Communication between the client device 100 and other devices may occur using any protocol or mechanism over a wired or wireless connection, or across a network 126. In some examples, the communications interface component 110 is operable with radio frequency (RF) and short-range communication technologies, e.g., near-field communication (NFC) tags, BLUETOOTH® brand tags, or the like. In some examples, the communications interface component 110 communicates with remote content memory of a remote device, such as a server or cloud infrastructure.

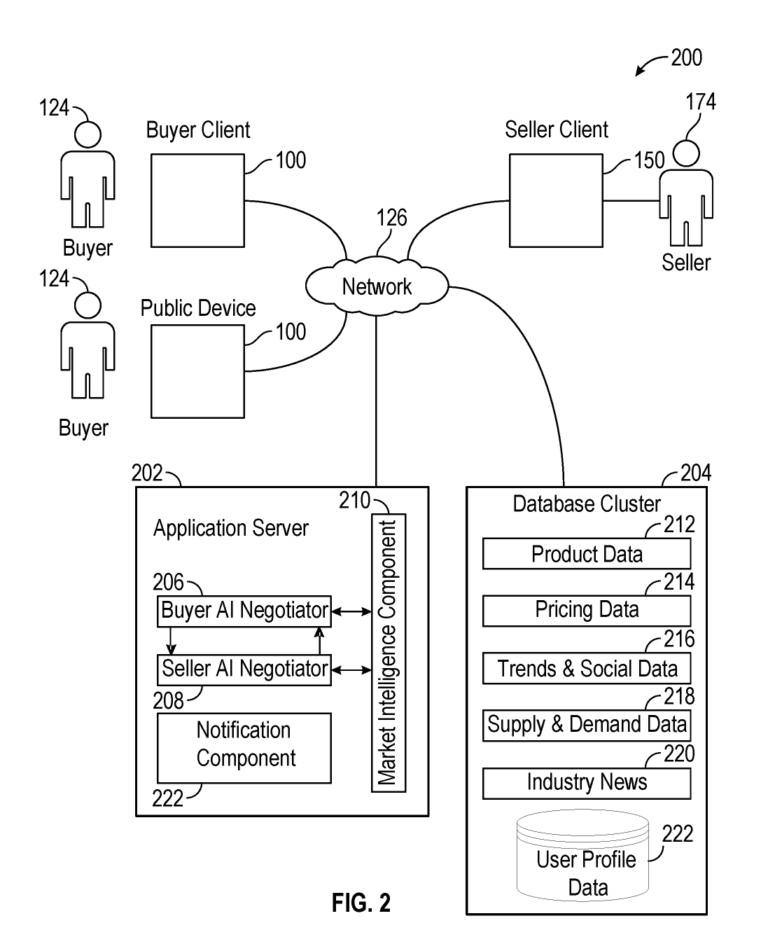

The network 126 may include any computer network, for example the Internet, a private network, local area network (LAN), wide area network (WAN), or the like. The network 126 may include various network interfaces, adapters, modems, and other networking devices for communicatively connecting the client devices 100, the application server 202, and the external song database cluster 204 referenced in FIG. 2. The network 126 may also include configurations for point-to-point connections.

In some examples, the user interface component 112 includes a graphics card for displaying data to the user and receiving data from the user. The user interface component 112 may also include computer-executable instructions (e.g., a driver) for operating the graphics card to display images or audio on or through the I/O components 104.

In operation, the AI buyer application 114 instructs the processor 102 to create an AI buyer agent upon direction of the buyer 124 using the buyer negotiation parameters 116 and buyer negotiation elasticity 118, either of which may include different weightings of importance. In some examples, the buyer 124 creates buyer plans that include the buyer negotiation parameters 116; elasticity 118; and/or the overall budget constraints, goals, and objectives of the buyer 124. The buyer 124 may enter the buyer negotiation parameters 116 and elasticity 118 through a front end of the AI buyer application 114, e.g., a user interface (UI) of an OS or downloaded application or a web page that the buyer 124 visits.

In some examples, the negotiation parameters 116 include the particulars regarding the purchasing scenario (e.g., what, when, how and with what cost/payment terms) of the buyer 124, as indicated in the buying plan. And some of these purchasing particulars may be implicitly derived from previously setup buying plans from the same buyer 124. In some examples, the AI buyer application 114 translates and handles purchasing parameters into negotiation points for interacting with the various seller AI negotiators 208.

The buyer 124 may specify the particulars of the product he or she is looking to purchase, including any combination of the following: product name, specifications, price (target or range), delivery, availability (e.g., whether the product is needed now or the buyer 124 is willing to wait a specific, configurable, amount of time), trendiness (as judged by the proliferation of the product being mentioned online through web sites or in social media), supply, demand, seasonality (e.g., spring collection of a particular shoe), or the like. In another example, the buyer 124 may add a set of products within the same category (e.g., cars) that he or she is interested in purchasing. In still another example, the buyer 124 may set the product category, a description related to the product, or a product to exclude when entering information about the product to be purchased.

Moreover, the buyer negotiation parameters 116 may indicate specific values, ranges, and/or weightings for the buyer parameter mentioned herein. For example, a range of specifications may be provided by the buyer 124 and designated as more important than a particular delivery date and price point. Moreover, in some examples, the buyer 124 may also specify corresponding buyer negotiation elasticity 118 for the any of the buyer negotiation parameters 116.

Alternatively or additionally, the buyer 124 may allow the buyer negotiation elasticity 118 to be dynamically set based on the automated negotiations with AI seller agents. For example, offers and counter-offers may be submitted and received by the AI buyer agent created on a server in response to the server receiving the buyer negotiation parameters 116 and 118. This enables the buying plan to remain dynamic in nature based on market, social, and interactive conditions. So the buyer negotiation parameters 116 and the buyer negotiation elasticity 118 may be statically set or dynamically influenced based on a sufficiently large (e.g., more than a certain preset number, more than an average number, etc.) group of AI seller agents' product offerings and uncovered seller parameters and corresponding seller elasticity. For example, the buyer negotiation parameters 116 may include a collection of specifications that the buyer 124 initially requested, but through negotiations with all available AI seller agents at a particular time, only a subset of specifications are available in for-sale products and the difference between what the buyer requested and the reality of product offerings exceeds a preset buyer negotiation elasticity 118. Consequently, constraints placed by the buyer negotiation elasticity 118 may be relaxed (thereby increasing the elasticity) and brought in line with the reality of the AI seller agents, and a subset of agent product offerings that fit within the relaxed buyer negotiation elasticity 118 may be presented to the buyer 124 for purchase.

The AI buyer application 114 may also instruct the processor 102 to present a list of optimal product offers for a requested product uncovered by the AI buyer agent created from the buyer negotiation parameters 116 and the buyer negotiation elasticity 118. For example, the AI buyer agent may negotiate potential deals with five different AI seller agents, which were identified from a hundred other AI seller agents deals that could not be negotiated in line with the requests of the buyer 124, and the five potential deals may be deemed to be optimal and presented to the buyer 124 for the ultimate purchasing decision. In other examples, the short list may be ranked using an overall matching score. In alternative examples, one of the five optimal potential deals may be automatically selected and a purchase made based preset buyer authorization in line with the buyer negotiation parameters 116. For example, if the five deals are all within the acceptance zones defined by buyer's negotiation elasticity 118, the AI buyer application 116—or the created AI buyer agent executing on the server—may automatically (i.e., without buyer 124 intervention) select and purchase the product from one retailer based on the weighted scores of the various negotiation parameters 116. In the event of a tie between the weighting scores, a retailer may be chosen either at random or based on other preferences from the buyer 124, such as the purchasing of products from domestic manufacturers, greener shipping procedures, or other parameter.

FIG. 1B is an exemplary block diagram illustrating a client device 200 for creating an AI seller agent. The client device 200 may take the form of any of the aforementioned client devices 100 and include the previously discussed processor(s) 202, I/O component(s) 204, and memory 206 as those referenced above and illustrated in FIG. 1A. Stored in memory 206 along with the operating system 208, communications interface component 210, and the user interface component 212 are instructions for an AI seller application 214. The AI seller application 214 captures and stores in memory 206 seller negotiation parameters 216 and seller negotiation elasticity 218. The seller negotiation parameters 116 may include any of the buyer and seller parameters mentioned herein, including, for example but without limitation, product information, product specifications, pricing, inventory (e.g., how many units are currently or will prospectively be in stock), shipping information (e.g., when products may be delivered), seasonality (e.g., when products are considered “in season” or “out of season”), trends (e.g., the amount or proportion of product sales at any given time), social media (e.g., discussion of particular products through various social media outlets), supply and demand (e.g., across multiple retailers), industry news, competition analysis data (e.g., pricing, pricing dynamics, product availability, etc.), and the like.

Additionally or alternatively, the buying negotiation parameters of FIG. 1A and the seller negotiation parameters or FIG. 1B may include any of the previously mentioned buying and selling goals and objectives. These buying and selling goals and objectives may be shared with multiple buyer and seller AI negotiators in order to implement collectively. For example, a revenue goal may be set by the seller 174, and the multiple seller AI negotiators may work in tandem to sell products to meet that goal, adjusting the prices offered based on the overall goal progress. In another example, a buyer 124 may set a particular set of product specifications to purchase (e.g., 35 cubicle desks) by a specific date, and multiple buyer AI negotiators may be set to purchase the desks within the timeframe, adjusting the price being paid as the deadline approaches.

Some examples implement the AI negotiators discussed herein in a cloud-based scenario. In such examples, the client devices 100 of the buyers 124 and the sellers 174 broadcast their respective buying plans and selling plans to servers that, in turn, create and manage the AI negotiators on behalf of the buyers and sellers.

FIG. 2 is an exemplary block diagram illustrating a networking environment 200 for providing AI negotiation agents to execute negotiation sessions between buyers 124 and sellers 174. Networking environment involves various buyer client devices 100, seller client devices 150, an application server 202, and a database cluster 204 that communicative over a network 126. The depicted devices are provided merely for explanatory purposes and are not meant to limit all examples to any particular set or type of devices. Also, the application server 202 and database cluster 204, while shown in singular boxes, may involve multiple physical or virtual (e.g., in a virtual machine architecture) servers or database structure.

In operation, as shown in networking environment 200, buyers 124 may create individual buying plans for products on any network-connected devices, such as the client devices 124 discussed above in relation to FIG. 1, and submit their buying plans across network 126 to the application server 202. Similarly, sellers 174 may create various selling plans on seller client devices 150 that are provided across the network 126 to the application server 202. For the sake of clarity, this disclosure refers to the client devices 100 of the buyers 124 as “buyer client devices 100” and the client devices 150 of the seller as the “seller client devices 150.” Additionally, some examples enable buyers 124 to create buying plans and access results of their buying plans on public devices 100, such as, for example but without limitation, networked public displays (e.g., televisions, monitors, etc.), electronic kiosks, public gaming devices, public displays in various transportation vehicles (e.g., taxis, planes, buses, autonomous cars, surfaces/panels inside autonomous cars, etc.), or the like.

The application server 202 is a server or collection of servers configured to create AI negotiation agents for the buyers 124 and sellers 174 based on the buying and selling plans. Specifically, in some examples, the application server 202 includes memory with executable instructions comprising a buyer AI negotiation agent (buyer AI negotiator) 206, a seller AI negotiation agent (AI seller negotiator) 208, a notification component 222, and a market intelligence component 210—all of which are executable by one or more server-side processors (not shown for clarity).

The database cluster 204 represents one or more backend storage devices (e.g., servers) configured to store, post-process, model and make available, various market data related to products being negotiated by buyer AI negotiators 206 and seller AI negotiators 208. This market data may include, for example but without limitation, product data 212, pricing data 214, trends and social data 216, supply and demand data 218, and industry news 220—all of which may be provided or obtained from online resources. Though not shown for the sake of clarity, public product offers, campaigns, advertisements, promotions, and the like may also be stored in database cluster 204 and used to influence the AI negotiators 206 and 208.

Additionally, the database cluster 204 stores user profile data 222 that includes unique identifiers of the buyers 123 (e.g., IDs, emails, account numbers, globally unique identifiers (GUIDs), demographics, gender, location, etc.), offers and purchasing history, negotiated offers and finalized deal terms of the users' buyer AI negotiators 206, and the like. For example, the user profile data 222 may be stored for a buyer 124 that indicates the buyer 124 has historically purchased products with premium product features (e.g., luxury vehicle options) at premium prices (e.g., more than a threshold amount than other buyers 124 purchasing the same luxury vehicle). In some example, offer and accepted deal terms between the buyers 124 and the sellers 174 are stored in relation to the buyers 124, sellers 174, or both as the user profile data 222, and this stored user profile data 222 may be exposed to buyer AI negotiators 206 and/or seller AI negotiators 208 to enhance product negotiations.

The buyers 124 may search for abstract product categories (e.g., car, phone, guitar, etc.) or down to specific product instances (e.g., a Tesla model S, Samsung Galaxy Note 5, Lumia 950™, Fender American Select Stratocaster, Gibson 1978, etc.) through a web page or software application. The buyers 124 may create and submit buying plans for particular products that include any of the aforementioned buying parameters and elasticity. For example, a buying plan may include a detailed description of a product, budget information, buying or delivery time line, product specifications wanted by the purchaser 124 (e.g., 64 MB of random access memory), or any other buying parameter. These buying plans are communicated to the application server 202, which in turn creates AI buying negotiators 206 to locate and negotiate product offering deals for the buyer 124 by communicating with the similarly seller AI negotiators 208, which take into account the seller parameters and elasticity anonymously from the buyer 124 and the seller 174 perspectives.

Thus, the buyers 124 may submit anonymous buying plans for specific products that include different timeframes, budgets, product information and specifications, and the like along with predefined buyer elasticity specifying various thresholds for these parameters. And sellers 174 may submit seller plans for their products that include any of the seller parameters and elasticity defined herein as well as particular sales strategies, plans, global strategic targets, or objectives for selling their products. Alternatively, the buyer and/or seller elasticity may be set or adjusted based on market conditions instead of being preset by the buyer and seller, respectively. For example, the delivery timeframe of a buying plan may be stretched a day or two by the buyer AI negotiator 206 when doing so affects a buying parameter for a deal.

The buyer AI negotiator 206 is created to take the submitted parameters and elasticity of the buyers 124's buying plan, find available product offers, and automatically (i.e., without buyer 124 interaction) negotiate deal offerings with AI seller negotiators 208 representing the various sellers 174 that have submitted selling plans for their products. Again, the sellers 174 may define flexible, adaptive product offerings as selling plans that include various seller parameters and the elasticity that may be influenced through negotiations with the various buyer AI negotiators 206 and/or information gathered about the current, historical, or prospective market for the particular products being offered and negotiated. To this end, deal parameters are negotiated between buyer AI negotiators 206 and seller AI negotiators 208 until either one (in some examples) or a group (in other examples) of potential offers are set for a given a product that can be presented to the buyers 124 for acceptance.

The buyer AI negotiator 206 intelligently, autonomously, and electronically represents the buyer 124 and negotiates deals with the seller AI negotiators 208 of various sellers 174 offering a particular product. Because the application server 202 may process offer parameters far faster than a human and also perform multi-dimensional comparisons using a vast amount of structured, semi-structured, or unstructured data—which is impossible for a user to evaluate in a reasonable timeframe, the buyer AI negotiator 206 for a single buyer 124 may identify and assess thousands of product offerings at once and negotiate the best deals for the buyer 124 through automated and interactive negotiations with the AI seller negotiators 208. To do so, the buyer AI negotiator may identify a seller AI negotiator for a given product, request product offering details (e.g., pricing, specifications, etc.), and (in some examples) submit potential bids for purchasing the products.

Negotiations between the buyer AI negotiators 206 and the seller AI negotiators 208 may be on matching what the buyers 124 plan to buy and what the sellers 174 plan to sell, taking into consideration the elasticity defined in both sides (e.g., specification, delivery, price, product information, etc.), the state of the market for the product, and in reference to the strategic goals or objectives of buyers or sellers (e.g., when the AI negotiators are looking to meet shared buying or selling targets). For instance, the state of the market may indicate how competitive a seller 174's price for product X is, how realistic the budget or timeframe of delivery is for the buyer 124, what the local or social trends are, what season the products are being requested, or the like. Additionally or alternatively, the elasticity may be influenced by market conditions determined by the buyer and seller AI negotiators 206 and 208, respectively, analyzing various data, or real-time data feeds, in the database cluster 204 exposed through the market intelligence component 210.

The market intelligence component 210 may be used by the buyer AI negotiator 206 and/or the seller AI negotiator 208 to access a repository of market, social, supply-and-demand, and industry data in a database cluster 204 in order to gauge the state of the market and influence the negotiations for product offers. Database cluster 204 may host, capture, provide access to various information from outside sources that are provided either directly or are gleaned from online sources. For example, product data 212 may indicate different product instances, competitive products, similar products, similarity metadata, specifications, descriptions, and the like. Pricing data 214 may indicate the various current, historic, and/or future prices of products, transcending across various markets and retailers. Trends and social data 216 may indicate different social trends determined from online sources like social media commentary, online articles, product comments, online reactions, online suggestions, online complaints, or the like. Supply and demand data 218 may indicate various demand statistics (e.g., number of buyers 124, buyer AI negotiators 206, sellers 174, or seller AI negotiators 208 currently in the market), order estimates of various sellers 174, sales information of the various sellers 174, and the like. Industry news 220 may include product announcements, releases, recalls, or other news from the products' manufacturers. The illustrated information sources in the database cluster 204 is expandable and may include additional or alternative information about the products being negotiated between the buyer AI negotiator 206 and the seller AI negotiator 208.

The database cluster 204 may also include specialized components processing incoming market, product, social, news, and industry data, either as structured, semi-structure, or unstructured formats. The output of these components may be a set of models and also a stream of scores or signals, keywords, and/or metadata enabling instant usage of these sources by the AI negotiators 206 and 208.

In some examples, the seller AI negotiator 208 uses product sales objectives, profitability targets, or price margins—within elasticity thresholds set by the sellers 174 or as a result of the market for the particular product—in order to create personalized offers adapted to each single anonymous buyer 124 represented by the buyer AI negotiators 206. The buyers 124 may receive offers, promotions, or advertisements in various examples that are aligned and relevant to the buyer 124's buying plans being expressed through a buyer AI negotiator 206. This may reduce the noise, spam, advertisement overexposure, and other annoyances to the buyers 124 that are popular in the digital era.

In some examples, the buyer AI negotiator 206 decides if there is a match worthy of being communicated to the user. To do so, the buyer AI negotiator 206 may make such a decision based on what offers terms have been negotiated and how close these negotiated terms are to the buying parameters set by the buyer 124 as well as how close other offered deals from other seller AI negotiators 208 are to the buyer 124's buying parameters. In this sense, the buyer AI negotiator 206 negotiates (anonymously, seamlessly, and/or concurrently) with many seller AI negotiators 208 of many different sellers 174 to obtain the most favorable deal terms for the buyer 124.

The buyer AI negotiator may communicate potential offers meeting the buyer 124's buying plan back to the client device 100 of the buyer for display to the buyer 124. The buyer 124 may accept; archive; discard; adjust the buying plan being executed by the buyer AI negotiator; adjust the buyer AI negotiator 206 re-negotiate offer terms, such as a specific lower price added by a user; gather market, social or public information about the product; ask for another negotiation round with an optional special request (e.g., price, availability, etc.); or a combination thereof. If the buyer 124 decides to accept an offer, the AI buyer agent may execute the negotiated offer accordingly.

Negotiations between buyer AI negotiators 206 and seller AI negotiators 208 may be conditional or relative based on the deal terms being offered by other seller AI negotiators 210, the market for the particular products, supply-and-demand figures, trends and social data, industry news, or a combination thereof. Additionally, in some examples, negotiations may be influenced (e.g., elasticity adjusted) based on the buyer 124 or seller 174 goals or objects. For example, if one seller AI negotiator 208 offers a product with a particular specification set for delivery in one week to a buyer AI negotiator 206, the buyer AI negotiator 206 may request multiple other seller AI negotiators 210 sell the product but with a shorter, expedited delivery time (e.g., within two days)

Similarly, the seller AI negotiators 206 may dynamically adjust product deal terms for a product based on the negotiated or offered terms of multiple buyer AI negotiators 206. For example, if multiple buyer AI negotiators 206 are offering the same price for a product, and the overall response from the seller AI negotiators 208 proves to be smaller than expected implying limited supply for the product at this price, a new seller AI negotiator 210 may raise the starting price of the product and then start negotiation sessions with buyer AI negotiators 206 to determine which ones want the product as the new market-adjusted price. In the same example, existing seller AI negotiators 208 may increase the price based on the same signals, and request the engaged Buyer AI agents to approve it. This multi-stage negotiation session may occur with any of the selling parameters and may be based on the level of interest in products at certain deal parameters, the market conditions, or a combination thereof.

In some examples, the buyers 124 and/or sellers 174 are presented with the deal parameters of negotiated offers for final acceptance. Alternatively, the buyer AI negotiator 206 and the seller AI negotiator 208 may be given autonomy to execute buying and selling on behalf of the buyer 124 and seller 174, respectively. To illustrate this latter scenario, a seller 174 may set a seller AI negotiator 208 to obtain at least a given profit margin on a particular product, given a cost of goods figure, for a set inventory of the product and may sell all of the inventory without seller 174 intervention, or may maximize, according to the strategy, the profit margin across a range of products within the same period; the volume of products sold; or combination thereof, including different targets for different products served by different seller AI negotiators 208. Likewise, the buyer 124 may, through his/her buying plan, set a buyer AI negotiator to purchase a particular product within a certain price so long as some mandatory product features (e.g., memory quantity, year/make of car, etc.) are included.

Multiple buyer AI negotiators 206 may be used for multiple different products, within the same time period, working together to reduce the total spent needed to acquire all the products. These buyer AI negotiators 206 may run under the same budget to be minimized or optimized (gains on price for product A, are used to increase price flexibility for other offers examined).

The notification component 222 transmits the negotiated offers to the buyer 124. Negotiated offers may be presented on a web page, through text or e-mail messages, via mobile or desktop apps, virtual reality, augmented reality, or holographic applications, on public display devices 100 (e.g., kiosks, billboards, etc.) at which the buyers 124 are recognized, or the like. In some examples the presentation of an offer may be triggered by or associated with the exact location of the user. Offers for the buyer 124 to consider may be exposed in a number of ways. A dedicated web page or a search engine or mobile application may reveal the negotiated offers obtained by the buyer AI negotiator 206. A public display device 100, such as a kiosk in a mall or airport, may detect that the buyer 124 is nearby and provide the latest negotiated offers. For instance, to further illustrate the case where a user is recognized at a public display device 100, such a device may be equipped with a camera and facial recognition software or a short-range radio frequency (RF) signal reader (e.g., via a BLUETOOTH® branded reader) that can be used to recognize the buyer 124 at the public display and present the buyer 124 with the potential offer(s) for their submitted buying plans. This allows the buyer 124 to set a buying plan for a particular product and simply wait for the buyer AI negotiator 206 to discover, negotiate and present relevant deals to the buyer 124 to consider over a particular time frame.

If a negotiated offer is accepted by both the buyer 124 and the seller 174, the buyer 124 may receive a GUID, claim identifier, QR code or related indicator detailing the negotiated offer. When used or scanned, such an indicator enables claiming the negotiated and agreed deal, and the indicator may be linked to a checkout procedure, for instance with a GUID ensuring that the checkout will execute the special offer/agreement for the specific buyer 124. Also, the buyer 124 may go online or physical store of the seller 174 and use the accepted offer or a promotion code indicating the offer to purchase the product. In the case of a physical store, the buyer 124 may use an application on a client device 100 (e.g., smart phone, wearable, tablet, etc.) and present a coupon detailing the offer, printout, message, NFC object, or other indication of the offer.

As previously mentioned, the buyer AI negotiators 206 and the seller AI negotiators 208, in some examples, operate to achieve particular buying and selling goals or objectives. Buying goals and objectives may be shared with multiple buyer AI negotiators 206, and selling goals and objectives may be shared across multiple seller AI negotiators 208. The goal-sharing AI negotiators 206 and 208 may be configured to adjust elasticity thresholds for particular negotiations based on achievement of the shared buying and selling goals. For example, if 10 seller AI negotiators are to cumulatively sell 100 guitars by end of the first quarter (i.e., March 31st), the prices may be more flexible the end of the quarter approaches if a certain number of guitars have not been sold or if sales of the guitar have flat lined. Similarly, on the buying side, if, for example, disparate parts for building a kit car need to be purchased by a certain date, elasticity regarding the price of the parts may be increased such that AI negotiators 206 are allowed to pay more money if a certain percentage of the parts are not obtained by an interim deadline. Obviously, far more examples exist; however, it should at least be noted that the disclosed buyer and seller AI negotiators 206 and 208 may be flexible and work together in order to achieve the purchasing objectives of the buyers 124 and the selling objectives of the sellers 174.

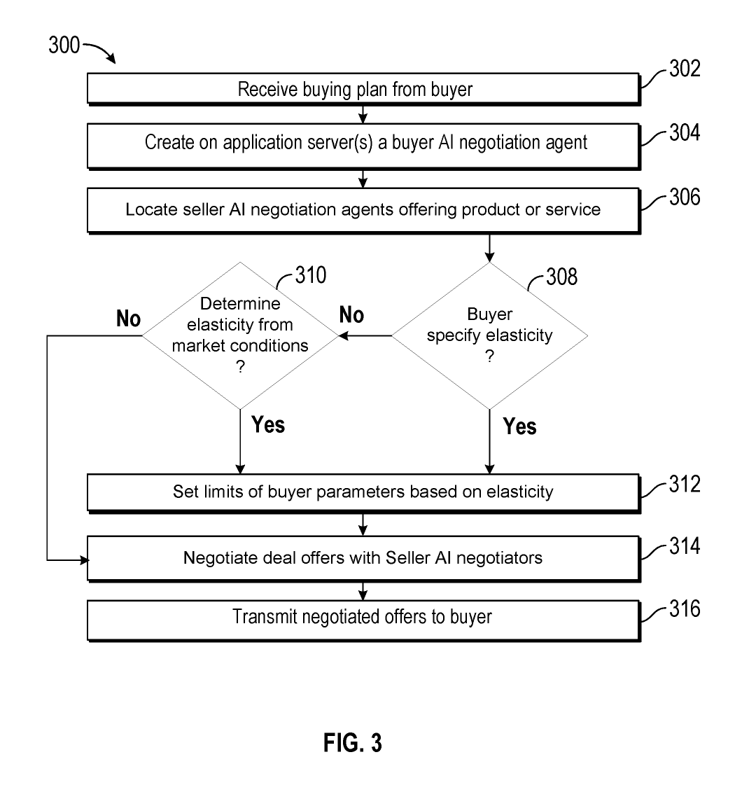

FIG. 3 is a flow chart diagram that illustrates a work flow 300 for creating and operating a buyer AI negotiator. Initially, a buyer 124 creates a buying plan by entering and submitting buying parameters, and optionally buying elasticity thresholds, through an online portal, an application, such as a web page or a software application to an application server 202. The application server 202 receives the buying plan of the buyer 124 (as shown at 302) and creates a buyer AI negotiation agent 206 (as shown at 304). The buyer AI negotiation agent 206 searches for and locates seller AI negotiation agents 208 offering the product specified by the buyer in the buying plan, as shown at 306.

A check may be performed to determine whether the buyer 124 specified elasticity thresholds or boundaries that the buyer AI negotiator 206 may adhere to when negotiating deal terms with the seller AI negotiators 208, as shown at decision box 308. For example, the buyer 124 may indicate particular product specifications that are necessary, unnecessary, or more/less important than other buying parameters, may indicate a particular delivery timeframe for receiving the product, may indicate pricing limits or percentages that are dependent on the market place (e.g., no more than 10% more than the average price of the last 50 purchases of a product from one or more sellers 174), and the like. If the buyer 124 specified elasticity thresholds, such limits are applied to the buying parameters by the buyer AI negotiator 124, as shown by the YES path from decision box 308 and 312.

If the buyer does not specify buyer elasticity thresholds, as shown by the NO path from decision box 308, the buyer elasticity may be determined, in some examples, from market conditions. To do so, the buyer AI negotiator 206 may use the market intelligence component 210 to access the product data 212, pricing data 214, trends and social data 216, supply and demand data 218, industry news 220, and/or user profile data 222 on the database cluster 204 and determine standard, average, dependent, conditional, or relative elasticity thresholds for the buying parameters based on product sales (historical or prospective) or different market or buyer characteristics.

Regardless of whether user-defined or market-dictated, if elasticity thresholds are specified, the elasticity thresholds are used to set limits on the buying parameters controlling the buyer AI negotiator 206 (as shown at 312), and then deal offers are negotiated with the identified seller AI negotiators 208 (as shown 314). Moreover, if no elasticity thresholds are set by the buyer 124 or the market conditions, the buyer AI negotiator 206 negotiates deal offers with the seller AI negotiators 208 without any elasticity—e.g., based solely on the buying parameters.

Offer terms are being negotiated through a multi-stage negotiation procedure between the buyer AI negotiator 206 and the identified seller AI negotiators 208. Each next stage in the multi-stage procedure may also quantify the rate of improvement in comparison to the initial offer and using the weight factors defined by the buyer 124. Using the rate of improvement and also the time-box defined, the procedure may be configured or decide to terminate. Negotiated offer terms may then be transmitted to the buyer 124, in some example, as shown at 316. Alternatively, in examples where the buyer 124 provides the buyer AI negotiator 206 with autonomy to accept offers, purchasing decisions for the product may be made automatically by the buyer AI negotiator 206 without input from the buyer 124.

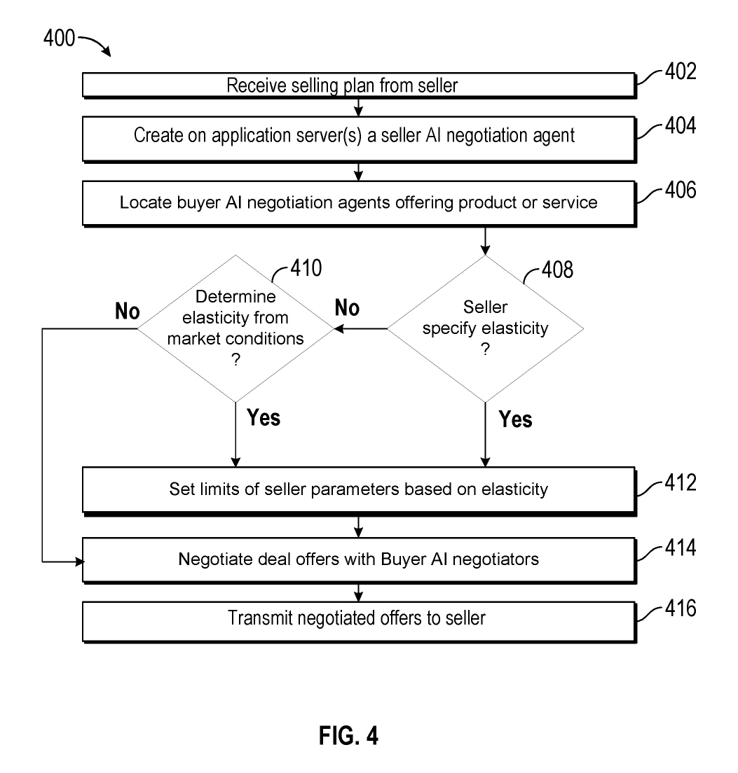

FIG. 4 is a flow chart diagram that illustrates a work flow for creating and operating a seller AI negotiator. Initially, a seller 174 creates a selling plan by entering and submitting selling parameters, and optionally selling elasticity thresholds, through an online portal, such as a web page or a software application to an application server 202, thereby allowing the seller to autonomously and quickly optimize revenue, profit margins, volume sold, and other sales metrics that conventionally required human-intensive sales forces. The application server 202 receives the selling plan of the seller 174 (as shown at 402) and creates a seller AI negotiation agent 208 (as shown at 404). The seller AI negotiation agent 208 searches for and locates buyer AI negotiation agents 206 offering the product specified by the buyer in the selling plan, as shown at 406.

A check may be performed to determine whether the seller 174 specified elasticity thresholds or boundaries that the seller AI negotiator 208 may adhere to when negotiating deal terms with the buyer AI negotiators 206, as shown at decision box 408. For example, the seller 174 may indicate particular profit margins for sales that take into account costs of the product being sold to the seller 174.

Regardless of whether user-defined or market-dictated, if elasticity thresholds are specified, the elasticity thresholds are used to set limits on the selling parameters controlling the seller AI negotiator 208 (as shown at 412), and then deal offers are negotiated with the identified buyer AI negotiators 206 (as shown 414). Moreover, if no elasticity thresholds are set by the seller 174 or the market conditions, the seller AI negotiator 208 negotiates deal offers with the buyer AI negotiators 206 without any elasticity—e.g., based solely on the buying parameters.

Offer terms are negotiated back and forth between the seller AI negotiator 208 and the identified buyer AI negotiators 206. Negotiated offer terms may then be transmitted to the seller 174, in some example, as shown at 416; though, not all offers need to be directly approved by the seller 174, in some examples. Alternatively, in examples where the seller 174 provides the seller AI negotiator 208 with autonomy to accept offers from buyers 124, purchasing decisions for the product may be made automatically by the seller AI negotiator 208 without input from the seller 174. Additionally, the seller 174 may register the negotiation steps, new offer terms proposed or received and the decision made at each stage of the negotiation process to support reporting, analytics, and sales or negotiation performance assessments from the seller AI negotiators 208.

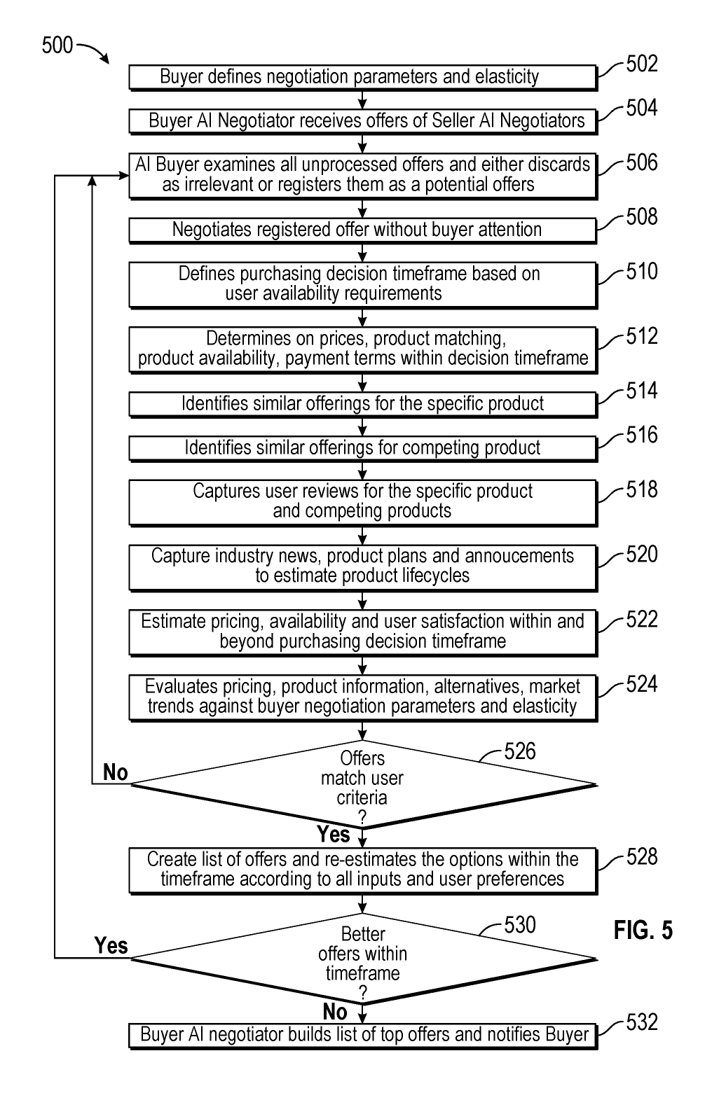

FIG. 5 is a flow chart diagram that illustrates a work flow 500 for a buyer AI negotiator 206 to locate and process negotiation offers from seller AI negotiators 210. Initially, a buyer 124 defines buying plan parameters and associated elasticity thresholds by submitting a buying plan to an application server 202, as shown at 502. A buyer AI negotiator 206 is created by the application server 202 that seeks to find product offerings for the product specified in the buyer 124's buying plan from seller AI negotiators 210. The buyer AI negotiator 206 examines unprocessed offers for the designated product from seller AI negotiators 210, as indicated at 506. The buyer AI negotiator 206 initiates negotiation sessions on offers for the product with the seller AI negotiators 210 without any user intervention from the buyer 124, as shown at 508.

A timeframe for purchasing the product (i.e., a “purchasing decision timeframe”) may be set based on the availability of the buyer 124 to accept or consider the offers, as shown at 510. For example, if the user is not connected to the Internet, traveling, or otherwise disposed for a certain period of time (e.g., work, calendared event, etc.), the timeframe may be set to indicate that only offers that may be timely considered by the buyer may be entertained. In some examples, the purchasing decision timeframe may be set based on the availability of a product offering insofar as the timeframe indefinitely extends until an indication from the seller AI negotiator 210 indicates the product offering is no longer valid. Some examples may not set or track a purchasing decision timeframe.

Statistics related to pricing, product matching, product availability, payments terms, delivery, or any other buying parameters associated with purchasing the specific product during the purchasing decision timeframe requested by the buyer 124 are obtained or calculated, as shown at 512. This information may be gathered from the seller AI negotiators 208 offering the product and/or the market intelligence component 210 that has access to the product data 212, pricing data 214, trends and social data 216, supply-and-demand data 218, and industry news 220 in the database cluster 204.

Negotiations between the buyer AI negotiator 206 representing the buyer 124 and seller AI negotiators 126 representing sellers 126 are conducted, and offers for the specific product are identified, as shown at 514. Additionally or alternatively, the offerings for competing products or products that do not include all the features of the product requested by the buyer 124 are identified, as shown at 516. User reviews for the identified specific and competing products may be captured (as shown at 520) along with industry news, product plans and announcements, or other publically available information in the database cluster 204 that may be used to estimate product lifecycles of the specific and competing products, as shown at 520.

Pricing, availability, and user satisfaction of the identified specific and competing products may be estimated—both within and beyond the purchasing decision timeframe, localized or adjusted to the local market of the buyers or sellers—as shown at 522. Moreover, as shown at 524, pricing, product information, product alternatives (e.g., with different product specifications), and market trends are evaluated against buyer negotiation parameters and elasticity thresholds designated by the buyer 124 in the buying plan being executed by the buyer AI negotiator 206, as shown at 524. In some examples, if the user reviews of the specific product indicate it is inferior compared to an identified competing product, the competing product may be given more deference when being later evaluated for suitability to fulfill the buyer 124's request.

Another example includes a “perfect” product with some good offers but with a sudden increase in social discussion related to a problem or a source of dissatisfaction, a news alert on a recall, previously unknown incompatibility with the local market of the buyer (e.g., a mobile phone with signaling problems under a specific type of local network); and/or a news alert on the announcement of the new model of the same product. All these could disqualify the particular product and/or produce alerts to the buyer AI negotiator 206, which, depending on the settings could be communicated to the buyer 124.

The uncovered offers from the seller AI agents 208 are then evaluated to determine whether any match the user's buying parameter criteria, as shown at decision box 526. If not, steps 506-524 are re-run. If so, however, a list of offers (if more than one) of the specific or competing products are created for the buyer 124 (in examples where the buyer 124 is set to approve purchases) or for the buyer AI agent 206 (for examples where the buyer 124 has delegated purchasing authority), and the deal options are re-estimated within the purchasing decision timeframe according to all inputs and user preferences—as shown at 528. If better offers are found, decision box 530 shows that steps 506-528 are re-run. If no better offers are found, the buyer AI negotiator 206 builds a list of top offers and notifies the buyer 124 accordingly, as shown at 532. The buyer 124 may then be notified of the top offers upon request or upon recognition at a public screen.

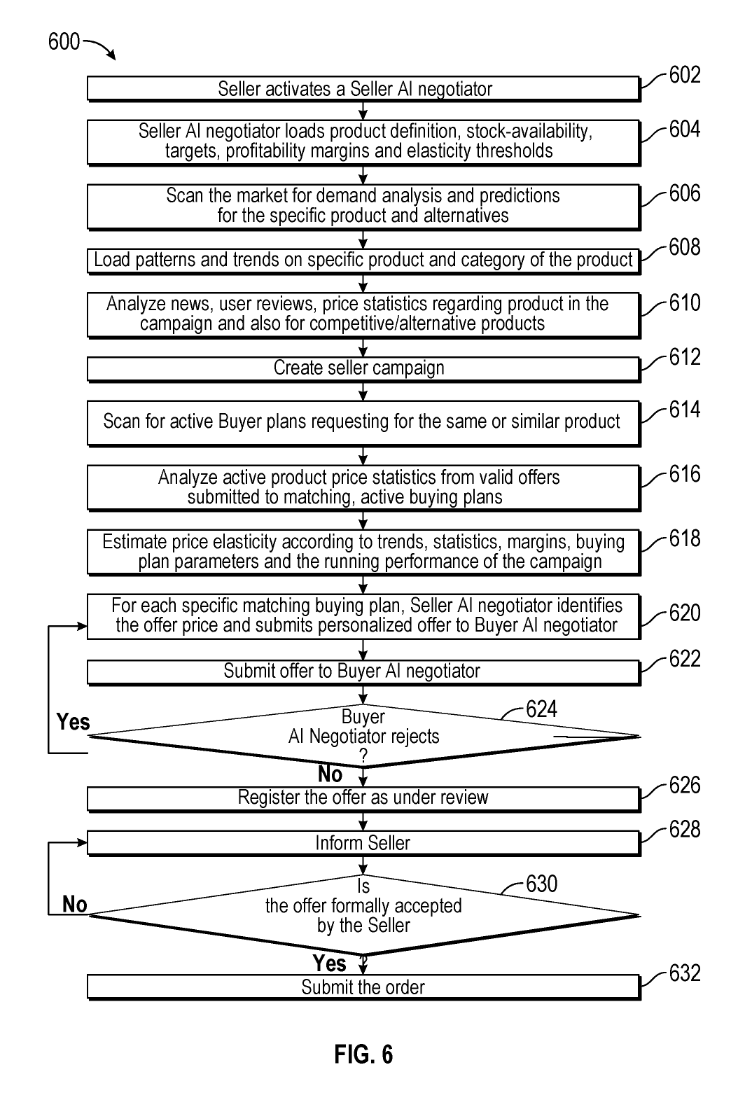

FIG. 6 is a flow chart diagram that illustrates a work flow 600 for a seller AI negotiator 208 to generate and negotiate product offers. Initially, a seller 174 creates and activates a seller AI negotiator 208 to offer a product, as shown at 602. A seller 174 may have multiple products or ranges of products to sell, and respective selling plans and corresponding seller AI negotiators 208 serving the seller 174's financial strategy. The seller AI negotiator 208 retrieves and loads product definition information (either from a product catalog, online source, manual entry by the seller 174, a combination thereof, or some other source), inventory stock-availability information, sales targets (e.g., quantity to sell in a sales timeframe), profitability margins, and seller parameter elasticity, as shown at 604.

The seller AI negotiator 208 scans the marketplace to perform a “demand analysis” for the product from the market data (e.g., based on any one or combination of the product data 212, pricing data 214, trends and social data 216, supply-and-demand data 218, and industry news 220 in the database cluster 204) and predicts the market viability selling potential for specific products and alternatives thereof. For example, a seller 174 of vehicles may notice that the price of a particular sport utility vehicle (SUV) is decreasing due to increased gasoline prices; whereas, a more fuel-efficient model (e.g., electric, hybrid, etc.) of the same SUV may be selling much faster due to the uptick in gasoline prices. This fuel-efficient model may be identified as a high-demand product to be selling in the current environment by the seller AI negotiator 208. Along these same lines, sales patterns and trend data on specific products and categories of products may be loaded to aid in shaping the demand analysis picture, as shown at 608.

Product in industry news, user reviews, price statistics, and the like about the products—and alternative products—for sale by the retailer 174 may be automatically analyzed for a given sales campaign, as shown at 610. Based on the news, user reviews, and price statistics, an effective campaign execution timeframe is estimated. Additional or alternative criteria may be used in this estimation. For instance, product specifications, social media, online sources, industry news (e.g., Tesla announces a new production line with capacity of 1000 model S cars per month to service the Brazilian, Irish, and German markets), and any other market or buyer/seller parameter described herein may be used to estimate the sales campaign timeframe. Along these same lines, seller parameters may be specified automatically based on the sales campaign timeframe or manually by the seller 174. In some examples, the seller AI negotiator 208 may then be created to execute the seller campaign based on the seller parameters, as shown at 612.

In some examples, the seller AI negotiator 208 on the application server 202 scans for active buyers 124 by scanning for associated buyer AI negotiators 206 that are attempting to negotiate buyer plans requesting the same or similar products than those offered by the seller 174, as shown at 614. The seller AI negotiators 208 may also have access to active product price statistics including competition pricing, offers and related insights of the specific and alternative products, either from previous sales of the seller 174, other seller AI negotiators 208, or buyer AI negotiators 206. The seller AI negotiator 208 analyzes active product price statistics from valid offers submitted to buyer AI negotiators 206, as shown at 616. The seller AI negotiator 208 also estimates price elasticity for the specific product being sold by the seller 174 based on the trends, sales statistics, profit margins, buying plan parameters, and the running performance of the sales campaign (e.g., how many products have sold and in what timeframe), as shown at 618

For each specific matching buying plan identified in the active buyer AI negotiators 206, the seller AI negotiator 208 identifies an offer price—as well as other offering terms (e.g., delivery, specification, etc.)—and prepares an adapted and negotiate offer for a (or multiple) buyer AI negotiator(s) 206, as shown at 620. The offer may then be submitted to the buyer AI negotiator 08, as shown at 622, to which the buyer AI negotiator 206 may accept, discard, or counter the or ask for a re-negotiation or new iteration based, possibly, on a specific ask (e.g., price, delivery method, etc.) from the seller 174. If the buyer AI negotiator 206 rejects the offer, work flow 600 repeats steps 620-622 to come up with a new offer, taking into account the recent rejection. In some examples, this portion (i.e., 620-624) of work flow 600 may be repeated until the buyer AI negotiator 206 accepts an offer from the seller AI negotiator 208, as shown by the NO pathway from decision box 624.

When an offer is accepted by the buyer AI negotiator 206, the accepted offer may be registered as “under review” or otherwise pending confirmation by the seller AI negotiator 208, as shown at 626. The seller 174 may then be informed of the offer acceptance, as shown at 628. The seller may be allowed to formally accept the offer, as shown at decision box 630. The seller AI negotiator 208 waits for the seller 174 to accept the offer, as shown by the NO path from decision box 630, until a timeframe expires (in some examples). If the seller 174 accepts the offer, a purchase order for the product may be created, as shown at 632, or a link to a checkout web page, including the identifiers mentioned above, or a coupon or other way to summarize the negotiated offer agreement in a claim ticket.

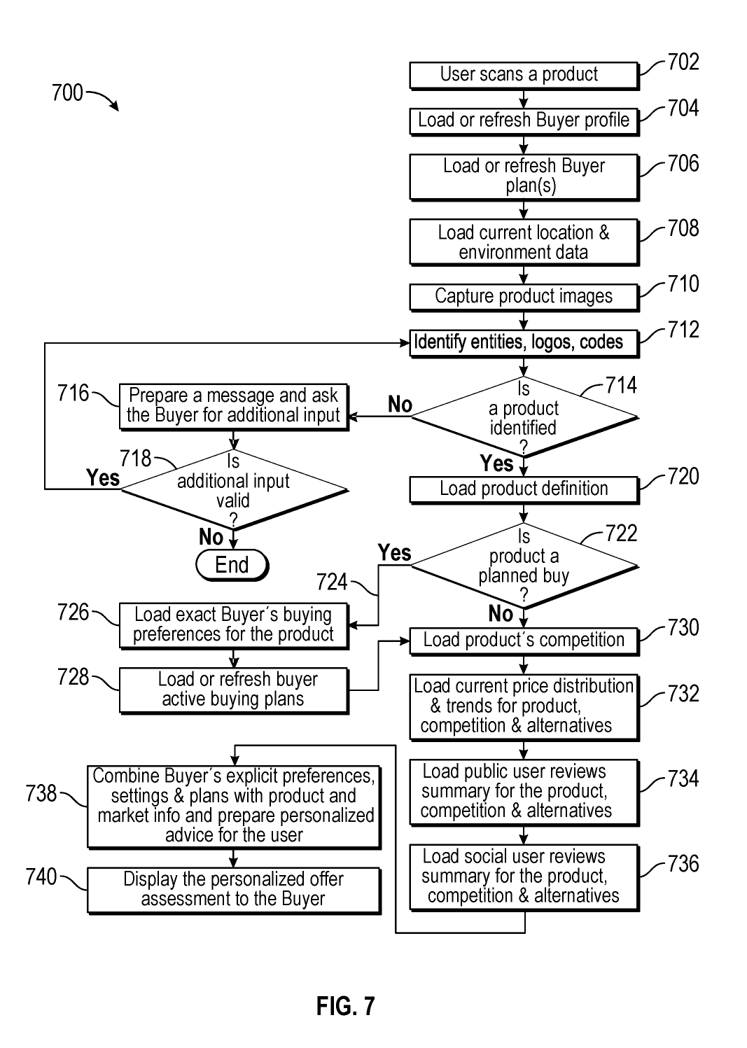

FIG. 7 is a flow chart diagram that illustrates a work flow 700 for assessing a product offer. A user may scan a product using their mobile client device 100, as shown at 702. The scanned identifier of the product may cause the client device to load or refresh a buyer 124 profile of the user, as shown at 704. This buyer 124 profile includes one or more buyer plans previously created by the buyer 124—and either fulfilled or not—as shown at 706. The buyer 124's current location and environment data may be obtained from the client device 100 and loaded, as shown at 708. Images of the scanned product may be captured online, as shown at 710, and product entity names, logos, and respective codes may be identified, as shown at 712.

The client device then determines whether the product has been identified, as shown at decision box 714. If not, the client device prepares a message asking the buyer 124 for additional input about the scanned product, as shown at 716. Received additional input from the buyer 124 about the scanned product is then evaluated to determine whether the additional input validly identifies the product, as shown at decision box 718. If not, the client device 100 quits. If so, however, work flow 700 repeats steps 712 and 714 to determine whether the product may be identified. If so, either based on the originally pulled product information or the subsequently supplied product information, a definition of the product may be loaded, as shown at 720.

The loaded product may be checked by the client device 100 to determine whether the product is a planned buy, as shown at decision box 722. If so, the buyer 124's buying preferences for the product, which may include any combination of the buying parameters mentioned herein, are loaded (as shown at 726), and the buyer 124's active buying plans—as implemented by the buyer AI negotiator 206—may be loaded and/or refreshed, as shown at 728.

Work flow 700 progresses to 730 if the scanned product is a planned product buy of the buyer 124 (e.g., the buyer 124 has previously submitted a buying plan and/or has an open buyer AI negotiator 206) in which case the scanned product's competition (i.e., competitive products) are retrieved and loaded by the client device 100, as shown at 730. For the scanned product and competitive products, current price prices or price distributions along with product trends are loaded (as shown at 732), as well as public user reviews and product summaries, as shown at 734. Social user reviews may also be uploaded, as shown at 736.

The buyer 124's explicit preferences from buying parameters in the buying plans are combined with market product information retrieved from the database cluster 204, as shown at 738. An assessment of the scanned product's price may then be obtained based on the competitive landscape and current, historic, and (possibly) prospective offers for the scanned product and its competitors. This assessment may then be presented to the buyer 124, as shown at 740. This enables the user to instantly get a solid answer on how good an offer is, according to his/her exact needs, preferences and priorities.

### Additional Examples

Some examples are directed to a device for creating an AI negotiation agent. The AI negotiation agent includes memory storing instructions for receiving buying parameters from a user for a product or service and a processor. The processor is programmed for: (1) determining at least one negotiation elasticity threshold associated with at least one of the buying parameters; (2) directing an application server to create the AI negotiation agent, based on the buying parameters and the at least one negotiation elasticity threshold associated with the at least one of the buying parameters, to represent automatically identify at least one seller of the product and negotiate offer terms for the product or service; (3) receiving the negotiated offer terms for the product or service; and (4) presenting the negotiated offer terms for the product or service to the user.

Some examples are directed to creating and managing a buyer AI negotiation agent. A buyer's buying plan for a product or service are received from a client device. The buying plan may include one or more buying parameters defined by the buyer. One or more application servers reactively create a buyer AI negotiation agent for locating the product or service at deal terms complying with the buying parameter of the user. Buyer elasticity thresholds associated the buying parameters are designated. And a plurality of seller AI negotiation agents offering the product or service are located. Deal terms are negotiated between the buyer AI negotiation agent and the seller AI negotiation agent for the product or service based on and in compliance with the buying parameters and the buyer elasticity thresholds. Out of these negotiations, negotiated offers from a subset of the seller AI negotiation agents are generated and then transmitted to the client device of the buyer for review and acceptance.

Some examples are directed to computer-executable memory, or multiple memories, for generating a seller AI negotiation agent offering a product or service according to a selling plan received from a seller and according to the selling strategy set by the seller (goals and objectives); wherein, the selling plan comprises selling parameters and associated selling elasticity (including the strategy components). A buyer AI negotiation agent is also generated requesting the product or service according to a buying plan received from a buyer; wherein, the selling plan comprises buying parameters and associated buying elasticity. The AI negotiation agent is also operable to analyze active product or service price statistics from historical offers of the product or service and correspondingly adjust deal terms offered to the buyer AI negotiation agent based the historical offers of the product or service. The buyer AI negotiation agent is also operable to receive the adjusted deal terms for the product or service from the AI negotiation agent and negotiate final offer terms with the seller AI negotiation agent. The final negotiated offer terms are transmitted to the buyer for acceptance.

Alternatively or in addition to the other examples described herein, examples include any combination of the following:
strategic achievement of buyer and seller goals and objectives through multiple AI negotiation agents working in tandem;
the buying parameters comprise at least one member of a group comprising product specifications, pricing, inventory, shipping information, seasonality information, trend information, supply and demand information, or industry news related to the product or service;
the application server comprises a server-side processor operable for receiving the buying parameters, accessing market condition information associated with the product or service over a network, determining the at least one negotiation elasticity threshold associated with the at least one of the buying parameters based on the market condition information, negotiating with a seller artificial intelligence negotiation agent on behalf of the user to determine the negotiated offer terms; and transmit the negotiated offer terms to a client device of the user;
the client device of the user comprises at least member of a group comprising a smart phone, a mobile tablet, a virtual reality device, or a wearable electronic device;
the client device of the user comprises a public device in a public area;
the negotiation elasticity threshold comprises an allowable deviation associated with the at least one of the buying parameters and/or the various buyer and seller goals and objectives mentioned herein;
the negotiation elasticity threshold is adjusted based on buyer buying parameters or seller selling parameters;
the negotiation elasticity threshold is based, at least in part, on market conditions associated with the product or service;
receiving a first acceptance from the buyer of the negotiated terms of the offer for the product or service, communicating the acceptance of the negotiated terms of the offer to a respective seller AI negotiation agent, receiving a second acceptance of the negotiated terms of the offer from a seller associated with the respective seller AI negotiation agent;
retrieving market information associated with the product or service, and adjusting the negotiated terms of the offer based on the market information;
the market information comprises product data, pricing data, trend data, social data, supply and demand data, and industry news;
the at least one negotiated offer is based, at least in part, on user profile data (e.g., location, previous or future purchases, preferences, likes, age, demographics, or the like) of the buyer;
the seller AI negotiation agent if operable for transmitting the final negotiated offer terms to a seller for acceptance;
the selling parameters and the buying parameters comprise product or service specifications, pricing, inventory, or delivery terms; and
the selling elasticity and the buying elasticity comprise a threshold associated with pricing, inventory, or delivery schedules for the product or service.

While the aspects of the disclosure have been described in terms of various examples with their associated operations, a person skilled in the art would appreciate that a combination of operations from any number of different examples is also within scope of the aspects of the disclosure.

### Example Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Exemplary computer storage media include hard disks, flash drives, and other solid-state memory. Communication media embody data in a signal, such as a carrier wave or other transport mechanism, and include any information delivery media. Computer storage media and communication media are mutually exclusive.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, holographic devices, virtual reality devices, augmented reality devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Machine learning, natural language processing, data mining, statistical modeling, predictive modeling, deep learning, neural networks, and game theory components may be implemented on the server-side components discussed herein. Some or all of these will be used to handle the multiple inputs. For instance, entities may be extracted from unstructured data, used to predict prices, used for certain optimization tasks, used to enable the AI negotiation agents disclosed herein to learn etc.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for interactive delivery of public content. For example, the elements illustrated in FIGS. 1A, 1B, and 2, such as when encoded to perform the operations illustrated in FIGS. 3-7, constitute exemplary means for automatically negotiating deal terms between buyers and sellers through the automated buyer and seller AI negotiation agents disclosed herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, media, and methods without departing from the scope of aspects of the disclosure, it is intended that all matter contained in the above description and shown in the accompanying drawings shall be interpreted as illustrative and not in a limiting sense.

What is claimed is:

1. An apparatus for creating an artificial intelligence negotiation agent, the apparatus comprising:
memory storing instructions for receiving buying parameters from a user for a product or service; and
a processor programmed for:
determining at least one negotiation elasticity threshold associated with at least one of the buying parameters,
directing an application server to create the AI negotiation agent, based on the buying parameters and the at least one negotiation elasticity threshold associated with the at least one of the buying parameters, to represent automatically identify at least one seller of the product and negotiate offer terms for the product or service,
receiving the negotiated offer terms for the product or service, and
presenting the negotiated offer terms for the product or service to the user.

2. The apparatus of claim 1, wherein the buying parameters comprise at least one member of a group comprising product specifications, pricing, inventory, shipping information, seasonality information, trend information, supply and demand information, or industry news related to the product or service.

3. The apparatus of claim 1, wherein the application server comprises a server-side processor operable for:
receiving the buying parameters;
accessing market condition information associated with the product or service over a network;
determining the at least one negotiation elasticity threshold associated with the at least one of the buying parameters based on the market condition information;
negotiating with a seller artificial intelligence negotiation agent on behalf of the user to determine the negotiated offer terms; and
transmit the negotiated offer terms to a client device of the user.

4. The apparatus of claim 3, wherein the client device of the user comprises at least member of a group comprising a smart phone, a mobile tablet, a virtual reality device, or a wearable electronic device.

5. The apparatus of claim 3, wherein the client device of the user comprises a public device in a public area.

6. The apparatus of claim 1, wherein the at least one negotiation elasticity threshold comprises an allowable deviation associated with the at least one of the buying parameters.

7. The apparatus of claim 6, wherein the at least one negotiation elasticity threshold is based, at least in part, on market conditions associated with the product or service.

8. The apparatus of claim 1, wherein the negotiated offer terms are presented to the user with an option to purchase the product or service.

9. A method for creating and managing a buyer artificial intelligence (AI) negotiation agent, the method comprising:
receiving, from a client device over a network, a buying plan of a user for a product or service, the buying plan comprising one or more buying parameters defined by a user;
creating, on one or more application servers, the buyer artificial intelligence (AI) negotiation agent for locating the product or service at deal terms complying with the buying parameter of the user;
designating buyer elasticity thresholds associated the buying parameters;
locating a plurality of seller AI negotiation agents offering the product or service;
negotiating deal terms between the buyer AI negotiation agent and the seller AI negotiation agent for the product or service based on and in compliance with the buying parameters and the buyer elasticity thresholds;
receiving a plurality of negotiated offers from a subset of the plurality of seller AI negotiation agents; and
transmitting the plurality of negotiated offers to a client device of the buyer.

10. The method of claim 9, further comprising:
receiving a first acceptance of the buyer of at least one of the negotiated offers for the product or service;
communicating the acceptance of the at least one of the negotiated offers to a respective seller AI negotiation agent;
receiving a second acceptance of the at least one of the negotiated offers from a seller associated with the respective seller AI negotiation agent.

11. The method of claim 9, further comprising:
receiving a buying goal of the buyer;
operating a second buyer AI negotiation agent to work in conjunction with the buyer AI negotiation agent to meet the buying goal; and
adjusting the buyer elasticity thresholds based on at least one purchase conducted through tee buyer AI negotiator.

12. The method of claim 11, wherein the market information comprises at least one member of a group comprising product data, pricing data, trend data, social data, supply and demand data, and industry news.

13. The method of claim 9, wherein the at least one negotiated offer is based, at least in part, on user profile data of the buyer.

14. The method of claim 9, wherein the at least one negotiated offer is based, at least in part, on user profile data of other buyers of the product or service.

15. The method of claim 9, wherein the client device comprises at least one member of a group comprising a smart phone, a mobile tablet, a virtual reality device, or a wearable electronic device.

16. The method of claim 9, wherein the one or more buying parameters comprise a buying objective shared between multiple buyer AI negotiation agents.

17. One or more computer-storage memories embodied with executable instructions, comprising:
a seller artificial intelligence (AI) negotiation agent executable on one or more servers for offering a product or service according to a selling plan received from a seller of the product or service, wherein the selling plan comprises selling parameters and associated selling elasticity, the selling elasticity being dynamically adjustable based on concerted selling of the seller AI negotiation agent and at least one other seller AI negotiation agent created for the seller;
a buyer AI negotiation agent executable on the one or more servers for requesting the product or service according to a buying plan received from a buyer, wherein the selling plan comprises selling parameters and associated selling elasticity;
wherein the seller AI negotiation agent is operable for:
analyzing active product or service price statistics from historical offers of the product or service, and
adjusting deal terms offered to the buyer AI negotiation agent based the historical offers of the product or service; and
wherein the buyer AI negotiation agent is operable for:
receiving the adjusted deal terms for the product or service from the AI negotiation agent,
negotiating final offer terms with the seller AI negotiation agent, and
transmitting the final negotiated offer terms to the buyer for acceptance.

18. The one or more computer-storage memories of claim 17, wherein the seller AI negotiation agent is further operable for:
monitoring other offered terms of the at least one other seller AI negotiation agent created for the seller against sales objectives specified of the seller; and
adjusting the selling elasticity of the at least one other seller AI negotiation agent based on the negotiated final offer terms and the sales objectives specified by the seller.

19. The one or more computer-storage memories of claim 17, wherein the selling parameters and the buying parameters comprise at least one member of a group comprising product or service specifications, pricing, inventory, or delivery terms.

20. The one or more computer-storage memories of claim 17, wherein the selling elasticity and the buying elasticity comprise at least one threshold associated with pricing, inventory, or delivery schedules for the product or service.
